(19) United States
(12) Patent Application Publication
(10) Pub. No.: US 2014/0134934 A1
(43) Pub. Date: May 15, 2014

(54) Humane Slaughter Tool

(71) Applicant: Accles & Shelvoke Limited, Sutton Coldfield West Midlands (GB)

(72) Inventor: Reeve John William Newton, Erdington Birmingham (GB)

(73) Assignee: Accles & Shelvoke Limited, Sutton Goldfield West Midlands (GB)

(21) Appl. No.: 14/078,682

(22) Filed: Nov. 13, 2013

(30) Foreign Application Priority Data
Nov. 13, 2012 (GB) 1220424.4

(51) Int. Cl. A22B 3/02

(52) U.S. Cl. CPC A22B 3/02
USPC 452/52

(57) ABSTRACT

A humane slaughter tool for dispatch of animals has a captive bolt accommodated within and coaxially of a barrel of the tool. The bolt is held in a cocked position against the biasing of a spring and is driven lengthwise of the barrel by a force applied thereto by the spring when the bolt is released. The tool further includes a manually operable cocking lever for returning the bolt to the cocked position. The cocking lever is pivotally mounted on the tool such that pivotal movement of the cocking lever is converted into a linear force to move the bolt against the biasing of the spring to the cocked position.

### CROSS-REFERENCE TO RELATED APPLICATIONS

This application claims the benefit of Great Britain Patent Application No. 1220424.4 filed on Nov. 13, 2012.

### TECHNICAL FILED OF THE INVENTION

The present invention relates to a humane slaughter tool for use with animals. The invention has particular, but not exclusive, application to tools used on farms for dispatch of sick or injured birds such as turkeys and chickens and other small animals such as piglets, rabbits and hares.

### BACKGROUND OF THE INVENTION

A common type of tool employs a captive bolt accommodated within and coaxially of a barrel of the tool that is adapted to be driven lengthwise of the barrel by an explosive force applied thereto by firing a blank cartridge in a breach block of the tool. The effective power developed by the bolt is determined by the explosive force applied to the bolt and the distance travelled when the bolt contacts the animal, more especially the distance the bolt projects from the barrel, and the power can be adjusted for varying classes of animals to be slaughtered by altering the explosive force and/or the distance travelled. Employing tools of this type incurs significant costs both in terms of the original outlay to purchase the tool and in terms of the cost of the blank cartridges used in the tool and in maintaining the tool in good working order. While such costs are viable for tools used to dispatch large animals such as cows, horses, sheep and pigs, there is a need for a tool that can be used to dispatch smaller animals such as birds where the power required is lower which does not require an explosive force generated by a firing a blank cartridge to drive the bolt.

The present invention has been made from a consideration of the foregoing. More especially, the present invention seeks to provide a humane slaughter tool that overcomes or at least mitigates the aforementioned disadvantages of the known tools employing blank cartridges.

### SUMMARY OF THE INVENTION

Thus, it is a desired aim of the present invention to provide a humane slaughter tool that avoids the use of an explosive force generated by firing a blank cartridge to drive the bolt.

It is a further desired aim of the present invention to provide such a humane slaughter tool that can be loaded in a safe and reliable manner.

According to the present invention, there is provided a humane slaughter tool for dispatch of animals including a captive bolt accommodated within and coaxially of a barrel of the tool, wherein the bolt is held in a cocked position against the biasing of a spring and is driven lengthwise of the barrel by a force applied thereto by the spring when the bolt is released, and the tool further includes a manually operable device for returning the bolt to the cocked position.

By this invention, energy stored in the spring when the bolt is held in the cocked position is used to drive the bolt when the tool is fired to release the bolt. In this way, the use of blank cartridges can be avoided with potential cost savings not only in terms of the cost of the cartridges but also in the cost and maintenance of the tool.

The spring rate can be matched to the bolt energy requirement and the manually operable device for returning the bolt to the cocked position allows the tool to be loaded in a safe and reliable manner. This may have particular benefit when the chosen spring has too high a rate for the bolt to be moved directly to the cocked position by hand.

It may be that the manually operable device for returning the bolt to the cocked position includes a cocking lever that is pivotally mounted on the tool such that pivotal movement of the cocking lever is converted into a linear force to move the bolt against the biasing of the spring to the cocked position.

It may be that pivotal movement of the cocking lever is transmitted to a slide member guided for linear movement in the direction of the length of the barrel when moving the bolt against the biasing of the spring to the cocked position. It may be that that the slide member is connected to the cocking lever by at least one lever arm pivotally connected to the cocking lever.

It may be that the cocking lever includes a handle pivotally mounted on the tool by at least one link arm rigidly attached to the handle and pivotally connected to the lever arm. The lever arm may provide a stop for the bolt when fired to limit travel of the bolt and thus the projection of the bolt from the barrel. In a preferred embodiment, two lever arms are provided on opposite sides of the barrel pivotally connected to two link arms attached to the handle. The handle may be telescopic so that it can be collapsed to a compact state when not in use and extended to increase its length when in use. In this way leverage of the cocking lever may be increased when it is required to return the bolt to the cocked position after firing. The cocking lever may be secured in a stored condition on the tool when not in use.

It may be that the bolt can be secured in the cocked position by engagement of a catch on the bolt with a latching point of a trigger on the tool. The trigger may be operable to release the bolt catch and allow the bolt to be driven lengthwise of the barrel by the energy stored in the spring. The trigger may include a safety catch to prevent accidental release of the bolt catch.

It may be that the trigger has more than one latching point spaced apart in the direction of bolt travel and the bolt can be secured in any selected one of a range of cocked positions by engagement of the bolt catch with the appropriate latching point on the trigger. Providing more than one latch point on the trigger allows the force of the spring acting on the bolt in the cocked position to be varied providing a range of power options when loading the tool. Additionally, the latching points allow movement of the cocking lever to withdraw the bolt past the latching points to secure the bolt in the selected cocked position but prevent return movement under the biasing of the spring acting on the bolt if the cocking lever is released as the bolt is withdrawn before the bolt is secured in the selected cocked position. Once the bolt is secured in the cocked position, the cocking lever may be returned to the stored condition.

### DESCRIPTION OF THE DRAWINGS

The invention will now be described in more detail by way of example only with reference to the accompanying drawings in which:

FIG. 1 is a side view of a tool embodying the invention with the bolt withdrawn in the cocked position prior to firing;

FIG. 2 is a side view of the tool shown in FIG. 1 with the bolt advanced in the stun position after firing;

FIGS. 3 and 4 show the operation of the mechanism for returning the bolt from the stun position to the cocked position after firing; and

FIG. 5 shows a modification of the tool shown in FIG. 1.

### DETAILED DESCRIPTION

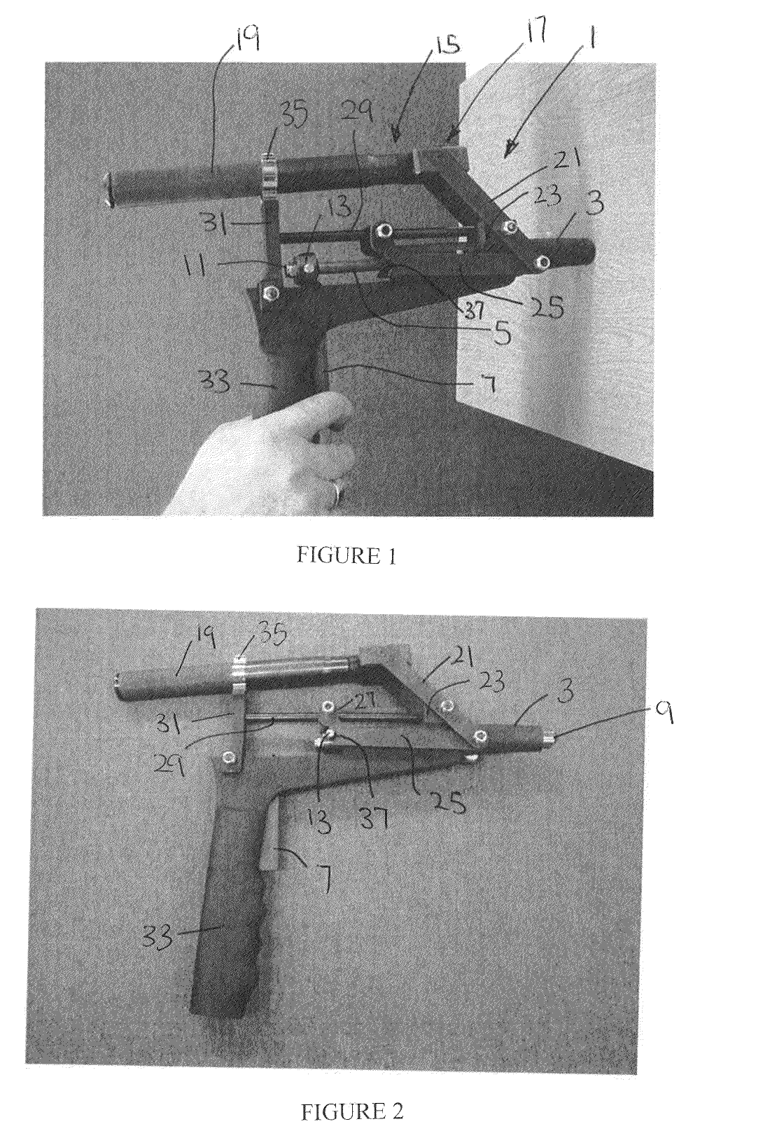

Referring first to FIGS. 1 and 2 of the drawings, a hand held humane slaughter tool 1 for dispatching small animals including, but not limited to, turkeys and chickens is shown. The tool 1 has a barrel 3, a bolt 5 and a trigger 7.

The bolt 5 is shown in FIG. 1 in the cocked position in which the front end or head 9 of the bolt 5 is withdrawn inside the barrel 3 and the rear end or tail 11 of the bolt 5 extends rearwardly from the barrel 3. The bolt 5 is held in the cocked position against the biasing of a spring (not shown) located inside the barrel 3 by engagement of latch point (not shown) on the trigger 7 with a catch 13 at the tail 11 of the bolt 5. The spring may be a compression spring that is compressed in the cocked position thereby storing energy that is released to drive the bolt 5 when the bolt catch 13 is released. Any other type of spring having an equivalent function may be employed.

The trigger 7 is operable to disengage the latch point and release the catch 13 so that the bolt 5 can advance to the stun position shown in FIG. 2 under the biasing of the spring in which the head 9 of the bolt 5 projects from the front end of the barrel 3. The distance the head 9 projects from the barrel 3 in the stun position is limited by engagement of the catch 13 with a mechanism 15 for returning the bolt 5 to the cocked position after firing. The distance the head 9 projects may be in the region of 20 mm but this is not limiting and the head may project more or less than 20 mm.

In use, the barrel 3 is placed against an animal to be dispatched with the bolt 5 in the cocked position and the trigger operated to release the catch 13 so that the bolt 5 is advanced by the energy stored in the spring and the head 9 of the bolt 5 strikes the animal. The strike force imparted to the animal by the head 9 of the bolt 5 is determined by the power of the spring and is chosen so that the bolt 5 delivers a concussive blow from which the animal will not recover.

The mechanism 15 for returning the bolt 5 to the cocked position after firing includes a cocking lever 17 having a telescopic handle 19 rigidly attached to a pair of link arms 21 that extend at an angle to the handle 19 on either side of the barrel 3 and are pivotally connected intermediate the ends to a block 23 mounted on the barrel 3. The link arms 21 are pivotally connected at the free ends to a pair of lever arms 25 that extend on either side of the barrel 3 and are pivotally connected at the free ends to a slider 27 mounted on a rod 29 that extends between the block 23 and a support 31 mounted above a hand grip 33 that incorporates the trigger 7. The rod 29 is arranged substantially parallel to the direction of movement of the bolt 5.

In use, with the bolt 5 in the cocked position, the cocking lever 17 is secured in a stored condition by engagement of the handle 19 with a spring clip 35 at the upper end of the support 31 as shown in FIG. 1. The handle 19 preferably extends substantially parallel to the length of the bolt 5 in the stored condition and may be collapsed to a compact state in the stored condition. In the stored condition, the ends of the pair of lever arms 25 connected to the slider 27 are spaced from the bolt catch 13 at the tail 11 of the bolt 5. If the trigger 7 is then operated to release the bolt catch 13, the bolt 5 is advanced under the biasing of the spring until the bolt catch 13 engages a pair of grooves 37 in the ends of the pair of lever arms 25 that act as stops as shown in FIG. 2 and limit the travel of the bolt 5 and the extend to which the head 9 of the bolt 5 projects from the barrel 3.

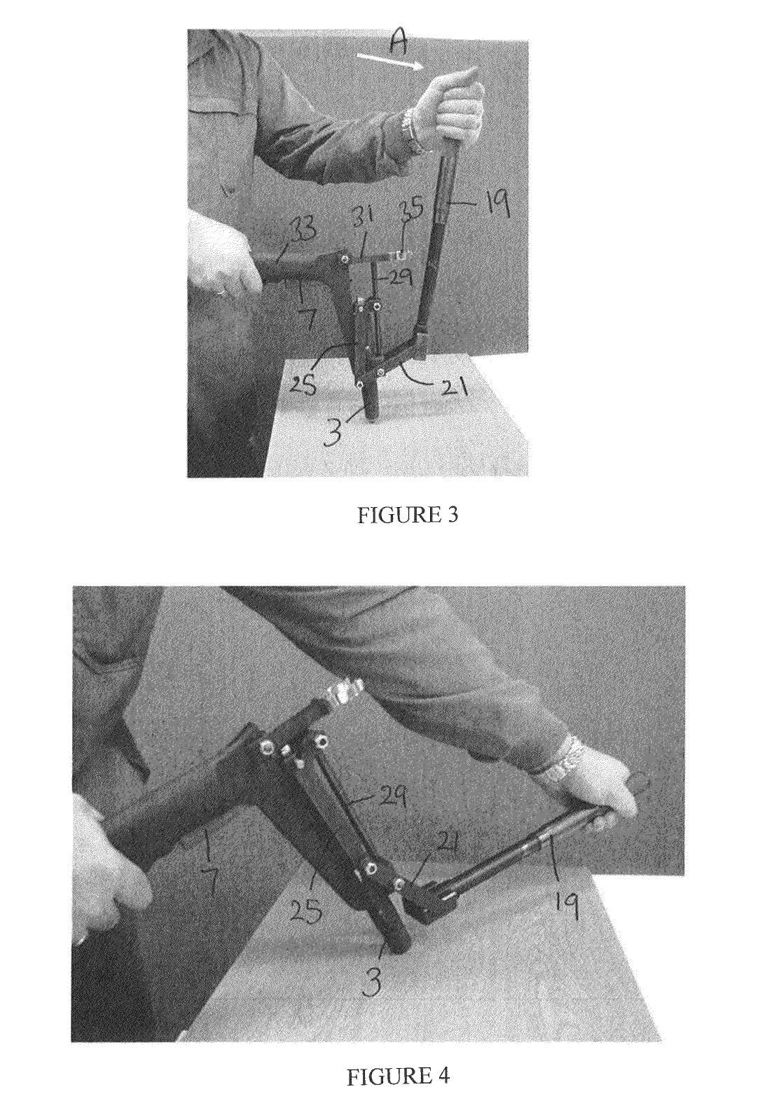

Referring now also to FIGS. 3 and 4, when loading the bolt 5 after firing, the cocking lever 17 is released by lifting the handle 19 out of the clip 35 and the handle 19 extended as shown in FIG. 3. The handle 19 is then pivoted about the block 23 in the direction of arrow A such that the pair of lever arms 25 guided by linear movement of the slider 27 along the rod 29 move towards the support 31 and the bolt 5 is withdrawn against the biasing of the spring by engagement of the bolt catch 13 in the grooves 37 until the latch point on the trigger 7 engages the bolt catch 13 as shown in FIG. 4 to secure the bolt 5 in the cocked position. In this way, angular movement of the cocking lever 17 is converted into a linear force to move the bolt 5 to the cocked position.

When the bolt 5 is secured in the cocked position, the cocking lever 17 can be returned to the stored position by pivoting the handle 19 about the block 23 in the reverse direction and the handle 19 collapsed prior to engagement with the clip 35 as shown in FIG. 1 with the pair of lever arms 25 spaced from the bolt catch 13. The tool 1 is then ready to be fired again by operating the trigger 7 to release the bolt catch 13 as described previously.

A safety catch (not shown) may be provided on the trigger 7 to prevent accidental firing of the tool 1. The safety catch may be released one handed by the firing hand of the operator holding the tool 1. In this way, the other hand of the operator is free and can be used to restrain the animal that is to be dispatched when positioning the barrel 3 against the animal prior to firing. As a result the tool can be accurately positioned on the animal with the loaded tool 1 in a safe condition and the safety catch released with the firing hand while the animal is held and the tool 1 fired to dispatch the animal. The safety catch also allows the operator to move among animals with the loaded tool 1 in a safe condition while selecting animals to be dispatched and then positioned and fired so that animals can be dispatched quickly on being selected and restrained and therefore do not suffer unnecessarily.

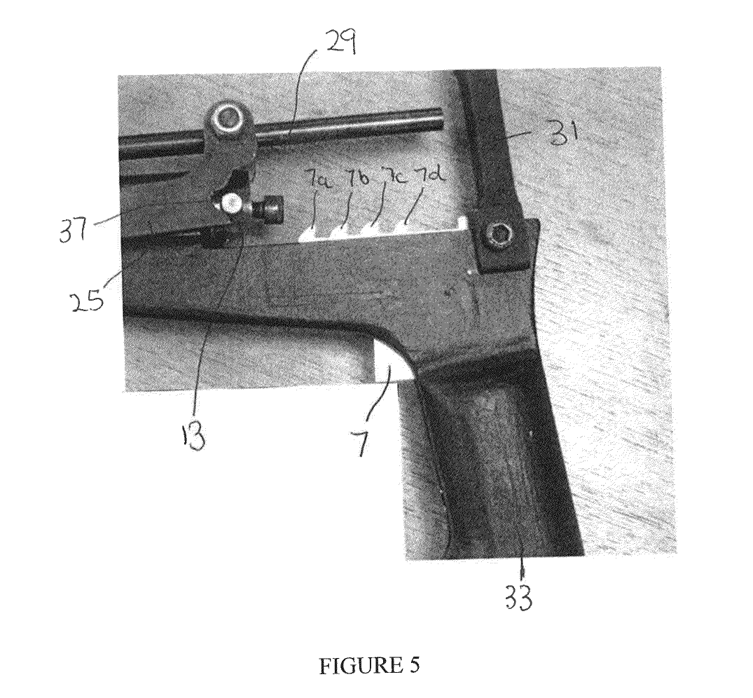

Referring now to FIG. 5, a modification to the above-described tool is shown in which like reference numerals are used to indicate corresponding parts. In this modification, the trigger 7 is provided with four latch points 7a, 7b, 7c, 7d spaced apart in the direction of travel of the bolt 5 for sequential engagement with the bolt catch 13 as the bolt 5 is withdrawn to load the tool 1. In this way, the bolt can be secured at any selected one of four cocked positions corresponding to engagement of the bolt catch 13 with the selected latch point 7a, 7b, 7c, 7d. The force of the spring acting on the bolt 5 increases as the bolt 5 is withdrawn to load the tool 1 and the different latch points 7a, 7b, 7c, 7d enable the tool 1 to be loaded with different spring forces. In this way a range of power options can be provided that the operator can select according to the size/condition of animal to be dispatched. For example, the tool 1 may have an operational power range covering smaller sizes of birds up to fully grown birds. This arrangement of multiple latch points 7a, 7b, 7c, 7d engageable with the bolt catch 13 also provides an additional safety feature when the handle 19 is pivoted to load the tool 1 by preventing the handle 19 being forcibly returned by the spring acting on the bolt 5 in the event the operator loses the grip on the handle 19 while loading the tool 1. In this way, the operator is protected from injury by the bolt 5 and/ or the cocking lever 17 as the bolt 1 is withdrawn if the handle 19 is released before the bolt catch 13 engages the selected latch point 7a, 7b, 7c 7d and, where provided, before the safety catch is engaged. Once the tool 1 is loaded and the bolt 5 secured in the selected cocked position, the handle 19 can be returned and the cocking lever 17 secured in the stowed position ready for firing. FIG. 5 shows an arrangement where the trigger 7 has four latch points 7a, 7b, 7c,7d but this is not limiting and the trigger may have more or less than four latch points. In another modification (not shown), a range of power options may be provided by engagement of a latch point on the trigger with any selected one of two or more catches on the bolt that are spaced apart in the direction of travel of the bolt.

The tool 1 may be cleaned and disinfected by immersion in a suitable cleaning and/or disinfection solution and may include one or more suitably positioned drainage points (not shown) that allow the solution to drain from the tool 1 so that the tool 1 can be sufficiently dry for firing in a short period of time.

As will be appreciated, the invention provides a hand operated tool 1 that is particularly suited for the dispatch of small animals by means of a spring loaded bolt 5 that generates sufficient force when the tool 1 is fired to dispatch the animal so that an explosive charge is not required to fire the tool 1. The manually operable cocking lever 17 also facilitates loading the tool 1 by withdrawing the bolt 5 through a system of levers to overcome the spring loading of the bolt 5 in a safe and reliable manner.

It will be understood that the invention is not limited to the embodiment described herein and that features of the tool may be altered, omitted or adapted according to the requirements of the tool. It will also be understood that the invention includes any novel feature described herein as well as combinations and sub-combinations of any of the features and equivalents thereof.

What is claimed is:

1. A humane slaughter tool for dispatch of animals comprising a captive bolt accommodated within and coaxially of a barrel of the tool, wherein the bolt is held in a cocked position against the biasing of a spring and is driven lengthwise of the barrel by a force applied thereto by the spring when the bolt is released, and the tool further includes a manually operable device for returning the bolt to the cocked position.

2. The tool of claim 1 wherein energy stored in the spring when the bolt is held in the cocked position is used to drive the bolt when the tool is fired to release the bolt.

3. The tool of claim 1 wherein the spring rate can be matched to the bolt energy requirement.

4. The tool of claim 1 wherein the manually operable device for returning the bolt to the cocked position includes a cocking lever.

5. The tool of claim 4 wherein the cocking lever is pivotally mounted on the tool such that pivotal movement of the cocking lever is converted into a linear force to move the bolt against the biasing of the spring to the cocked position.

6. The tool of claim 5 wherein pivotal movement of the cocking lever is transmitted to a slide member guided for linear movement in the direction of the length of the barrel when moving the bolt against the biasing of the spring to the cocked position.

7. The tool of claim 6 wherein the slide member is connected to the cocking lever by at least one lever arm pivotally connected to the cocking lever.

8. The tool of claim 7 wherein the lever arm provides a stop for the bolt when fired to limit travel of the bolt and thus the projection of the bolt from the barrel.

9. The tool of claim 7 wherein the cocking lever includes a handle pivotally mounted on the tool by at least one link arm rigidly attached to the handle and pivotally connected to the lever arm.

10. The tool of claim 9 wherein two lever arms are provided on opposite sides of the barrel pivotally connected to two link arms attached to the handle.

11. The tool of claim 9 wherein the handle is telescopic so that it can be collapsed to a compact state when not in use and extended to increase its length in use.

12. The tool of claim 4 wherein the cocking lever can be returned to a stored position when the bolt is secured in the cocked position.

13. The tool of claim 1 wherein the bolt is secured in the cocked position by engagement of a catch on the bolt with a latching point of a trigger on the tool.

14. The tool of claim 13 wherein the trigger has a plurality of latching points spaced apart in the direction of travel of the bolt and the bolt can be secured in any selected one of a range of cocked positions by engagement of the bolt catch with the appropriate latching point on the trigger.

15. The tool of claim 14 wherein the latching points allow movement of the cocking lever to withdraw the bolt past the latching points to secure the bolt in the selected cocked position but prevent return movement under the biasing of the spring acting on the bolt if the cocking lever is released as the bolt is withdrawn before the bolt is secured in the selected cocked position.

16. The tool of claim 13 wherein the trigger is operable to release the bolt catch and allow the bolt to be driven lengthwise of the barrel by the energy stored in the spring.

17. The tool of claim 16 wherein the trigger includes a safety catch to prevent accidental release of the bolt catch.

18. The tool of claim 17 wherein the safety catch can be released once the bolt is secured in the cocked position.

19. A humane slaughter tool for dispatch of animals comprising a captive bolt accommodated within and coaxially of a barrel of the tool, wherein the bolt is held in a cocked position against a resilient biasing force and is driven lengthwise of the barrel by the biasing force when the bolt is released, and the tool further includes a manually operable device for returning the bolt to the cocked position.

20. A humane slaughter tool for dispatch of animals comprising a captive bolt accommodated within and coaxially of a barrel of the tool, wherein the bolt is held by a catch in a cocked position against a resilient biasing force and is driven lengthwise of the barrel by the biasing force when the bolt is released, and the tool further includes a manually operable cocking lever for returning the bolt to the cocked position in which the bolt is secured by the catch, whereupon the cocking lever is movable to a position in which the cocking lever provides a stop to limit travel of the bolt when the catch is released.
